(19) United States
(12) Patent Application Publication
(10) Pub. No.: US 2006/0223700 A1
(43) Pub. Date: Oct. 5, 2006

(54) Methods for forming porous oxide coating layer on titanium dioxide (TiO2) particle surface and titanium dioxide (TiO2) powder and film manufactured therefrom

(75) Inventors: Hyun-Suk Jung, Seoul (KR); Kug-Sun Hong, Seoul (KR); Jeong-Ryeol Kim, Seoul (KR); Jin-Young Kim, Seoul (KR); Jong-Sung Park, Kyungki-do (KR); Sang-Wook Lee, Seoul (KR); Dong-Wook Kim, Seoul (KR); Jun-Hong Noh, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SEOUL NATIONAL UNIVERSITY INDUSTRY FOUNDATION, Seoul (KR)

(21) Appl. No.: 11/393,440

(22) Filed: Mar. 30, 2006

(30) Foreign Application Priority Data
Mar. 31, 2005 (KR) 10-2005-0027221
Jun. 27, 2005 (KR) 2005-55910

(51) Int. Cl. C01G 23/047; B05D 7/00; B01J 23/00

(52) U.S. Cl. 502/350; 423/610; 427/212

(57) ABSTRACT

Disclosed is a method for providing photochemical activity by coating a nano-layer of metallic oxide with nano-sized micropores on the particles or film of titanium dioxide (TiO₂). The method for coating the nano-layer of porous oxides with hyperfine nano-sized pores on titanium dioxide (TiO₂), comprising producing the solution containing metallic salts, providing the solution of metallic salts with TiO₂ powder, hydrating the metallic salts and coating the hydrates on the TiO₂ powder surface, and forming oxides from the hydrates coated on the TiO₂ powder surface. The formed porous oxide coating layer increases the absorption capacity of water or dye molecules by increasing the specific surface area of titanium dioxide (TiO₂) particles, thereby improving a photocatalyst characteristic or dye-sensitized fuel cell characteristic of TiO₂.

### CLAIM FOR PRIORITY

This application is based on and claims priority to Korean Patent Application No. 2005-55910 filed on Jun. 27, 2005 in the Korean Intellectual Property Office (KIPO), the entire contents of which are hereby incorporated by reference.

### BACKGROUND

1. Field of the Invention

Example embodiments of the present invention relate in general to the field of a method for increasing photochemical activity, such as photocatalyst characteristic or solar cell characteristic, by reforming a titanium dioxide (TiO₂) surface, and more particularly to a method for increasing photochemical activity by coating a metal oxide nano-layer having nano-sized micropores on the TiO₂ particles or film.

2. Description of the Related Art

A titanium dioxide (TiO₂), as a semiconductor material, causes electrons to be excited from a valence band to a conduction band and forms holes (h+) in the valence band illuminated with ultraviolet rays which have higher energy than a band gap. These electrons and holes move to a surface of titanium dioxide (TiO₂) powder and lead to redox reaction or generate heat via recombination. The electrons of the conduction band reduce oxidants like oxygen (O₂+H⁺+e−→HO₂.) and the holes of the valence band oxidizes a reductant (H₂O+h⁺→OH.+H⁺). Particularly, the holes formed in the above-described process generate hydroxyl radical (OH.) by oxidizing H₂O molecules or OH— ions absorbed on the titanium dioxide (TiO₂) surface. This hydroxyl radical (OH.) is so active that it oxidizes non-degradable organic materials such as phenol, and others, and decomposes the materials easily. Therefore, in order to easily decompose organic materials like odors in the atmosphere through titanium dioxide (TiO₂) catalyst, abundant H₂O molecules or OH— ions should be able to be absorbed on the TiO₂ surface.

Meanwhile, titanium dioxide (TiO₂) has been used as a photoelectrode of dye-sensitized solar cell that converts solar energy into electric energy according to the principle of photoelectrochemical operation. Since dye-sensitized nano particle titanium dioxide (TiO₂) solar cell was developed by Michael Gratzel research group at Ecole Polytechnique Federale de Lausanne (EPFL) of Switzerland in 1991, many researches have been performing studies in this solar cell field.

In contrast to a silicon solar cell, the dye-sensitized solar cell is a photoelectrochemical solar cell which is mainly composed of dye molecules capable of generating electron-hole pairs by absorbing visible rays, and the titanium dioxide (TiO₂) photoelectrode which transfers the generated electrons. The dye-sensitized solar cell is expected to replace the existing amorphous silicon solar cell since it has higher energy conversion efficiency as well as a lower manufacturing cost compared with the existing p-n type solar cell.

According to Korean Patent Application No. 10-2000-32002, since the energy conversion efficiency of a solar cell is proportional to the electron quantity generated by light absorption, quantity of dye molecules, which are coated on the titanium dioxide (TiO₂) surface, should be increased in order to generate more electrons. Accordingly, in order to increase the concentration of the absorbed dye molecules per unit area, preparation of nano-sized titanium dioxide (TiO₂) particles has been primarily required, and various methods for reforming the surface of TiO₂ particles have also been suggested.

As described above, the more OH— ions and dyes are coated on the titanium dioxide (TiO₂) surface, the more superior a performance TiO₂ can have superior performance as the photocatalyst and the solar cell, respectively. Thus, technologies for reforming the TiO₂ surface are needed. For instance, Japanese Unexamined Patent Application No. 2001-139331 discloses a method of improving photocatalytic characteristics of the titanium dioxide (TiO₂) by adding alkaline compounds such as sodium hydroxide (NaOH) to the TiO₂ sol. Moreover, Japanese Unexamined Patent Application No. 2002-159865 discloses a titanium oxide photocatalyst that improves removal capacity of basic gas by coating the TiO₂ particle as core with silica hydrates. Korean Patent Application No. 2002-0031054 discloses a method that reforms the titanium dioxide (TiO₂) surface into acid or base of Brønsted by adding dozens of acidic or alkaline metallic oxides and hydrates such as zirconium, vanadium, and others, to the TiO₂ particles. Additionally, there was an instance in which the photocatalytic characteristics of titanium dioxide (TiO₂) were improved by adding MgO powder of a quantity greater than 1 μm to TiO₂. (Refer to J. Bandara et al., Applied Catalysis B: Environmental 50 (2004) 83-88).

The examples of the titanium dioxide (TiO₂) surface reformation to improve the characteristics of the dye-sensitized solar cell with nano-particle oxide are as follows:

First, Korean Unexamined Patent Application No. 2003-0032538 discloses a method that increases photocurrent by forming a mixture layer of TiO₂ and titanosilicalite-2, increasing light scattering and improving the light absorption characteristics of dyes. Korean Unexamined Patent Application No. 2003-007320 discloses a method that improves the characteristics of the solar cell by adding acetified compounds or chlorides containing positive ions with acidic level 2 or 1 to titanium dioxide (TiO₂).

However, the conventional methods are merely methods that improve photochemical characteristics by simply coating metallic oxides, hydrates, acetified compounds, chlorides, and others, on the TiO₂ surface and mixing them with TiO₂.

### SUMMARY

An object of the present invention is to provide method of reforming a titanium dioxide (TiO₂) particles and a surface of a TiO₂ film so as to increase the photochemical activity of the TiO₂.

Another object of the present invention is to provide a titanium dioxide (TiO₂) powder and a TiO₂ film, having improved photochemical activity.

According to an aspect of the present invention, there is a method of coating a porous oxide nano-layer with hyperfine nano-sized pores on a titanium dioxide (TiO₂), comprising: providing a solution containing metallic salts; providing the solution of metallic salts with a TiO₂ powder; hydrating the metallic salts and coating the hydrates on the said TiO₂ powder surface; and forming oxides from the hydrates coated on the TiO₂ powder surface.

According to an aspect of the present invention, there is provided a method of coating a porous oxide nano-layer with hyperfine nano-sized pores on a titanium dioxide (TiO₂) layer, comprising: providing the solution containing metallic salts; forming hydrates through hydration of the metallic salts; coating the hydrates on a surface of the TiO₂ powder by providing the said solution with the TiO₂ powder; and forming oxides from the hydrates coated on the TiO₂ powder surface.

According to an aspect of the present invention, there is provided a method of coating a porous oxide nano-layer with hyperfine nano-sized pores on titanium dioxide (TiO₂) layer, comprising: providing the solution containing metallic salts; dipping a titanium TiO₂ film in the solution of metallic salts; hydrating the metallic salts and coating the hydrates on the surface of the TiO₂ film; and forming oxides from the hydrates coated on the TiO₂ film.

According to an aspect of the present invention, there is provided a method of coating a porous oxide nano-layer with hyperfine nano-sized pores on titanium dioxide (TiO₂), comprising: providing the solution containing metallic salts; forming hydrates through hydration of the metallic salts; dipping a TiO₂ film in the solution of metallic salts and coating the hydrates on the surface of the TiO₂ film; and forming oxides from the hydrates coated on the surface of the TiO₂ film.

It is desirable that the hydrates include at least one selected from the group composed of lantanium hydroxide (La(OH)₃), nickel hydroxide (Ni(OH)₂), calcium hydroxide (Ca(OH)₂), iron oxide hydroxide (FeOOH), aluminum hydroxide (Al(OH)₃), aluminum oxide hydroxide (AlO(OH)), and cobalt hydroxide (Co(OH)₂).

It is desirable that the metallic salts include at least one selected from the group composed of carbonates, nitrates, sulfates, ammonium salts, chlorides, organic salts, and alkoxides.

It is desirable that the oxides include at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO). Here, it is desirable that the amount of metallic salts in the solution be decided so that the content of the aforementioned oxides ranges between 0.02 wt % and 10 wt % compared with titanium dioxide (TiO₂).

It is also desirable that the hydrates are formed at the temperature between 5˜90° C.

According to an aspect of the present invention, there is provided a titanium dioxide (TiO₂) powder composed of the TiO₂ particles, containing a porous oxide layer with a thickness less than 10 nm and basic surface iso-electric point on a surface of the powder.

According to an aspect of the present invention, there is provided a titanium dioxide (TiO₂) film, containing a porous oxide layer with a thickness less than 10 nm and basic surface iso-electric point on a surface of the film.

It is desirable that the pores in the oxide layer be formed through the topotactic phase transition from metallic hydrates.

According to an aspect of the present invention, there is provided a titanium dioxide (TiO₂) film composed of the TiO₂ particles, containing a porous oxide layer with a thickness of less than 10 nm and basic surface iso-electric point on a surface of the film.

The titanium dioxide (TiO₂) powder and film may be used as a photocatalyst or electrode material of a solar cell.

The present invention shall not be limited to the technical objects described above. Other objects not described herein will be more precisely understood by those skilled in the art from the following detailed description.

### BRIEF DESCRIPTION OF THE DRAWINGS

Example embodiments of the present invention will become more apparent by describing in detail example embodiments of the present invention with reference to the accompanying drawings, in which:

FIG. 1 shows a transmission electron microscope photo of magnesium oxide (MgO) (i.e., Black dots) with nano-sized pores (i.e., White parts) obtained by heating magnesium hydroxide (Mg(OH)₂) as an intermediate reactant at 350° C. to form a oxide layer according to an exemplary embodiment the present invention;

FIG. 2 is a transmission electron microscope photo illustrating an image where MgO nano oxide layer is uniformly coated on the titanium dioxide (TiO₂) particle according to an exemplary embodiments of this present invention;

FIG. 3a is a graph illustrating the results of measuring a photolysis rate of stearic acid depending on the MgO coating dose of the TiO₂ powder coated with MgO nano oxide layer according to the exemplary embodiments of this present invention;

FIG. 3b is the FT-IR (Fourier Transform-Infrared) spectrum of the titanium dioxide (TiO₂) powder coated with 0.1 wt % magnesium oxide (MgO) and for comparison, FT-IR spectrum of the titanium dioxide (TiO₂) powder that is not coated with magnesium oxide (MgO) according to the exemplary embodiment of this present invention;

FIG. 4a shows the measurements of I-V characteristics for a titanium dioxide film according to the coating dose of magnesium oxide (MgO) oxide layer according to the exemplary embodiment of this present invention;

FIG. 4b shows a UV spectroscopic spectrum of dye molecules absorbed on the titanium dioxide (TiO₂) surface according to the exemplary embodiment of this present invention;

FIG. 5a is an FT-IR spectrum of stearic acid on the titanium dioxide (TiO₂) film which is not coated with MgO and shows the degradation behavior of stearic acid, according to the exemplary embodiments of this invention;

FIG. 5b is an FT-IR spectrum of stearic acid on the titanium dioxide (TiO₂) film which is coated with MgO and shows the degradation behavior of stearic acid according to the exemplary embodiments of this invention;

FIG. 6a is a transmission electron microscope photo illustrating calcium oxide which is uniformly coated around titanium dioxide (TiO₂) according to the exemplary embodiments of this invention; and

FIG. 6b is a graph illustrating the measurements of I-V characteristics of the titanium dioxide (TiO₂) dye-sensitized solar cell film which is coated with various kinds of metallic oxide layers containing nano-sized pores according to the exemplary embodiments of this invention;

### DETAILED DESCRIPTION OF EXEMPLARY EMBODIMENTS

Subject matters and features of the exemplary embodiments of the present invention will be covered by the detailed description and drawings.

Advantages and features of the present invention and methods of accomplishing the same may be understood more readily by reference to the following detailed description of the exemplary embodiments and the accompanying drawing. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

As described above, this invention includes processes of coating metallic hydrates on the titanium dioxide (TiO₂) surface from the metallic salt solution, and then coating nano-sized metallic oxides through topotactic phase transition from the metallic hydrates to metallic oxides. At this point, the metallic oxides coating has a porosity represented by the micropores generated during the topotactic phase transition. A surface area of the titanium dioxide (TiO₂) for absorbing hydroxyl radical (OH—) or dye becomes wider due to the porous coating layer, thereby improving the photocatalytic reactivity and dye absorption characteristic. Additionally, the porous coating layer makes it easy to absorb dyes with carboxyl group by controlling the surface iso-electric point of titanium dioxide (TiO₂) powder so as to be maintained as a basic. (Refer to Kay A, Gratzel M. CHEMISTRY OF MATERIALS 14 (7): 2930-2935 JUL 2002).

Exemplary embodiments of the present invention will be described in detail with reference to the accompanying drawing.

Hereinafter, the method of coating porous oxide nano-layer with hyperfine nano-sized pores on the titanium dioxide (TiO₂) surface will be described in detail according to the exemplary embodiments of this present invention.

First, metallic salt solution is provided as a precursor to form a porous oxide coating layer. Here, the metallic salt may be composed of combination of one or two more of carbonates, nitrates, sulfates, ammonium salts, chlorides, organic salts, alkoxides, and others. It is desirable that the metallic salts be provided by dissolving it in the aqueous solvents like water or organic solvents like alcohol and then stirring uniformly.

Next, the titanium dioxide (TiO₂) powder is mixed with the metallic salts solution so as to proceed to hydration reaction, At this point, when alkoxides are used as metallic salts, additional pH adjustment is not needed, however, when another metallic salt is used, the addition of an acid or base may be needed in order to adjust appropriately pH according to kinds of the metallic salts. Since it is obvious to those skilled in the art that pH adjustment is necessary for hydration reaction, it will not be explained in detail.

Preferably, the hydration reaction is executed at a temperature between 5˜90°, and in a hydrothermal reactor, if needed. In case of metallic alkoxide, hydration reaction is developed without addition of a separate acid or base, thereby being capable of obtaining precipitates.

Desirable hydrates, according to the present invention, include lantanium hydroxide (La(OH)₃), nickel hydroxide (Ni(OH)₂), calcium hydroxide (Ca(OH)₂), iron oxide hydroxide (FeOOH), aluminum hydroxide (Al(OH)₃), aluminum oxide hydroxide (AlO(OH)), and cobalt hydroxide (Co(OH)₂) as examples and can be obtained through combination of these.

According to the present invention, the methods of coating the metallic hydrate nano layer on the titanium dioxide (TiO₂) powder include, for example, the method of compounding TiO₂ with metal ions after hydration and the method of obtaining nano coating layer by hydrating metal ions with TiO₂ in the solution. In order to obtain a uniform coating layer, both methods are all available but the latter is more desirable. Moreover, more uniform nano coating layer can be obtained with Ball-Milling treatment in the coating step.

A method of coating the metallic hydrate nano layer on the titanium dioxide (TiO₂) film includes, for example, the method of coating the metallic hydrate solution on the TiO₂ film through dipping or spinning after precipitating metal ions and the method of obtaining nano coating layer by hydrating metal ions in state that the TiO₂ film is dipped in the solution.

As described above, after metallic hydrate layer is formed on the titanium dioxide (TiO₂) surface, metallic oxide is formed by heating the TiO₂ coated with the hydrate.

A metallic oxide forming reaction, according to the present invention, is proceeded to along with dehydration. The following reaction equations are obtained according to kinds of the formed hydrates.

$$\begin{matrix}\frac{{M ( OH )}_{2} \to M O + {H}_{2} O}{( M = Mg , Ca , Co , Ni )} & [ Equation 1 ] \\ \frac{2 {M ( OH )}_{3} \to {M}_{2} {O}_{3} + 3 {H}_{2} O}{( M = Al , La )} & [ Equation 2 ] \\ \frac{2 M OOH \to {M}_{2} {O}_{3} + {H}_{2} O}{( M = Al , Fe )} & [ Equation 3 ]\end{matrix}$$

While the hydration reaction proceeds, hydrates with low density are shifted to nano-sized oxides with high density and specific surface area is dramatically increased through the generation of nano-sized pores. In this step, the temperature for the heat treatment (dehydration) is preferably between 200˜900° C. If the temperature for the heat treatment is under 200° C., the hydration reaction may be proceeded to very slowly or hardly developed, and if the temperature for the heat treatment is over 900° C., according to the particulate growth, large specific surface area can't be obtained due to the observable decrease in the pore size.

Desirable oxides, in this present invention, are CaO, Al₂O₃, NiO, CoO, La₂O₃, Fe₂O₃, etc., for instances, which can cause topotactic phase transition at the time of phase transition from hydrates, and one or more of these oxides may be mixed within the coating layer. It is desirable that the content of the oxides toward titanium dioxide (TiO₂) be controlled so as to be between 0.02 wt % and 10 wt %. Accordingly, considering this, the concentration of metallic salt may need to be adjusted when the metallic salt solution is prepared. In the case where the content of the metallic oxide is below 0.02 wt %, formation of metallic oxide (increase in water or dye absorption capacity of the surface) has observably decreased and In the case where the content of the metallic oxide is over 10 wt %, electric characteristics required as a photocatalyst or solar cell cannot be satisfied due to the strong resistance of the metallic oxide itself as a nonconductor.

Hereafter, in the following, various respects of this present invention will be described in detail through the desirable exemplary embodiments.

The exemplary embodiment 1 is describing the generation mechanism of magnesium oxide with nano-sized pores in this invention previously mentioned.

### EXAMPLE 1

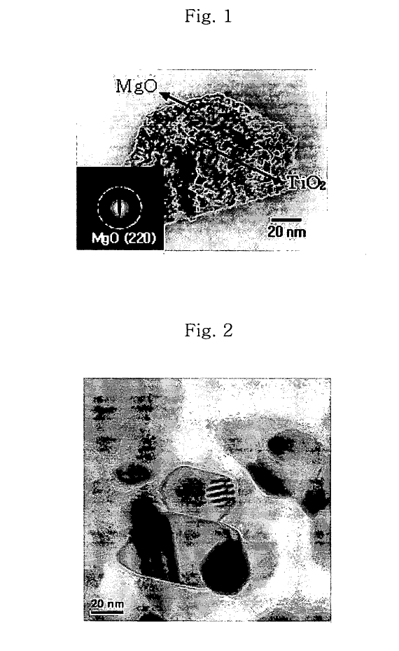

Magnesium hydroxide (Mg(OH)₂) was obtained by adding 10 cc of 6 wt % magnesium methoxide (Mg(OCH₃)₂) dissolved in methanol to 100 cc of 80° C. water, stirring for around 1 hour, and drying at 100° C. FIG. 1 is a transmission electron microscope photo of magnesium oxide (MgO) with nano-sized pores obtained by treating the said magnesium hydroxide (Mg(OH)₂) with heat at 350° C. As shown in the illustrated transmission electron microscope photo, it is shown that hexagonal tabular magnesium hydroxides (Mg(OH)₂) larger than 1 μm were finely split into several nm of magnesium oxide (MgO) and the number of formed nano-sized pores was observably increased. The specific surface area of this magnesium oxide (MgO) was measured as 673 m²/g. Specific surface area was measured by using BET surface area analyzer, ASAP2010, manufactured by Micromeritis Corporation in the USA.

### EXAMPLE 2

Uniform coating slurry was obtained by mixing 0.013 cc of 6 wt % magnesium methoxide (Mg(OCH₃)₂) (weight ratio of MgO to TiO₂:0.03 wt %) dissolved in methanol with 10 cc of 25° C. water dispersed with 3 g of the nano-sized TiO₂ powder (P-25 Degussa powder, Germany), stirring for 1 hour, adding 10 cc of ethanol and 0.4 cc of acetyl acetone (CH₃COCH₂COCH₃), and performing 24-hour Ball-Milling process. Then, the TiO₂ particles applied with uniform MgO oxide layer were manufactured by heating at 400° C. after drying the coating slurry at 100° C.

FIG. 2 is a transmission electron microscope photo illustrating the image of the TiO₂ powder with nano coating layer, obtained from this exemplary embodiment. From this photo, it is recognizable that a several nm thick magnesium oxide layer was uniformly coated on the surface of TiO₂ particle.

The specific surface area of the TiO₂ powder obtained from this exemplary embodiment was measured by using the BET surface area analyzer.

As the result of measurement, while the specific surface area of the TiO₂ powder not coated with MgO was 47.5 m²/g, the specific surface area of the TiO₂ powder coated with MgO was greatly increased, i.e., 55.4 m²/g. The fact that specific surface area was greatly increased only when coated with MgO of 0.03 wt % weight ratio means that nano-sized fine porous structures were formed on the MgO coating layer.

### EXAMPLE 3

After manufacturing the TiO₂ powder coated with MgO oxide layer under the same conditions as described in Example 2, while differing the content of the coated MgO, photocatalytic characteristics of TiO₂ were evaluated according to the content of the coated MgO. For evaluation of photocatalytic characteristics, the TiO₂ particles coated with MgO oxide were coated on the quartz plate and developed as film. The TiO₂ film was obtained by adding 20 cc of ethanol to the slurry obtained in Example 2 and spin-coating on the quartz plate (3000 rpm per time) after stirring. Photocatalytic characteristics were evaluated after heating each coating layer at 400°. Target organic acid of photocatalytic reaction was stearic acid (CH₃(CH₂)₆COOH) and a light of UV wavelength was illuminated for 18 minutes according to the method conducted by Y. Paz (Y Paz et al., J. Mater. Res., Vol 10, p 2842, 1995).

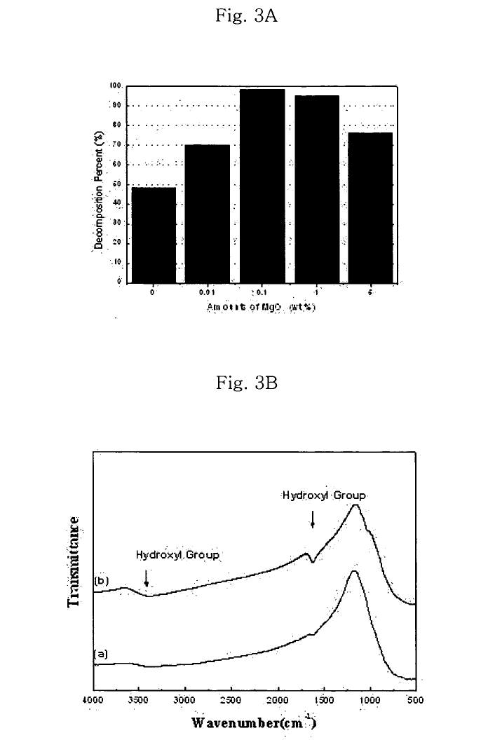

FIG. 3a illustrates the results measuring the photolysis rate of stearic acid depending on the coated magnesium (MgO) dose. Here, the coated magnesium (MgO) dose represents a converted value as weight at the time when the metallic salts contained in the solution are completely formed into oxides.

From the above graph, it is recognizable that the decomposition efficiency of the stearic acid was greatest when 0.1 wt % of MgO was coated. FIG. 3b is the FT-IR (Fourier Transform-Infrared) spectrums of the titanium dioxide (TiO₂) powder both coated with 0.1 wt % MgO and not coated with MgO. Observing that the peak absorption intensity of water was very high when coated with MgO, it is recognizable that the water absorption capacity of the TiO₂ powder surface was steeply increased. From this, it is appreciated that the photolytic effect was consequently increased when MgO coating with nano-sized pores caused increase in water absorption capacity of TiO₂ powder surface as well as specific surface area previously measured.

### EXAMPLE 4

After the titanium dioxide (TiO₂) powder coated with MgO oxide layer was prepared under the same conditions as Example 2, while differing MgO coating dose, the characteristics of the dye-induced TiO₂ solar cell were evaluated. Slurry was manufactured under the same conditions as Example 2, and the coated MgO oxide dose was adjusted depending on an adding dose of the magnesium alkoxide. From the manufactured slurry, a 5 mm×5 mm sized film was coated onto the ITO substrate. Production and measurement of the film were made, based upon the process conducted by Gratzel, etc. (J. Am. Chem. Soc. 1993, 115, p 6382).

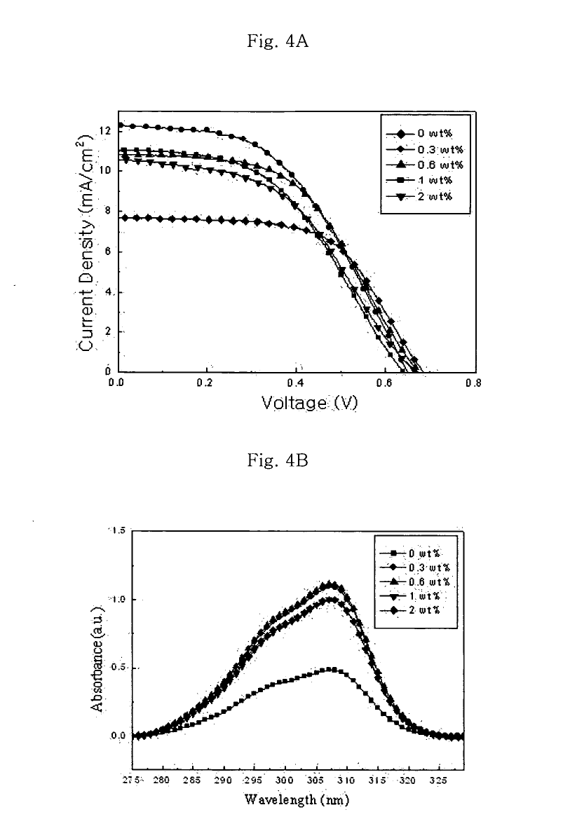

FIG. 4a is a graph illustrating the measurements of current density of the manufactured TiO₂ films, according to the coated dose of MgO oxide. The light-to-electric energy conversion efficiency calculated from the current density of the FIG. 4a is listed in Table 1 below.

TABLE 1

| | MgO content (wt %) | | | | |
|---|---|---|---|---|---|
| | 0 | 0.3 | 0.6 | 1.0 | 2.0 |
| Light-to-electric | 2.5 | 3.8 | 3.5 | 3.3 | 3.2 |
| energy conversion | | | | | |
| efficiency (%) | | | | | |

It is recognizable that the efficiency level was 2.5 in the case where the added MgO dose was 0 wt %, however, it increased to 3.8 in the case of 0.3 wt %.

FIG. 4b shows the UV spectrum results of the NaOH solution dissolved with dye molecules which are originally absorbed on the TiO₂ surface but dissolved in the NaOH solution. Observing that the UV absorption peak intensity of the dye molecules absorbed in the TiO₂ surface coated with MgO was greater than otherwise, it is recognized that the absorption capacity of the dye molecules increased considerably by MgO coating. It is considered that this is not only because MgO coating layer is porous but because MgO itself is a base with higher iso-electric point than TiO₂ resulting in stronger bond with dyes containing carboxyl group. Such an increase in absorption capacity of MgO dyes with nano-sized pores has a great effect on the augmentation of the characteristics of the solar cell.

### EXAMPLE 5

In the above-described embodiments, the photocatalytic characteristics of TiO₂ were evaluated by manufacturing the TiO₂ film after coating MgO oxide layer on the TiO₂ particles. Unlike these, in Example 5, the photocatalytic characteristics of TiO₂ were evaluated by forming the pure TiO₂ film and subsequently coating MgO oxide film containing nano-sized pores onto it. The TiO₂ film was manufactured by coating TiO₂ by spin-coating onto a quartz plate with the same conditions as Example 3. Separately from this, MgO sol was prepared for MgO coating by mixing 7.88 cc of 6 wt % magnesium methoxide (Mg(OCH₃)₂), 0.56 cc of water, and 0.08 cc of acetic acid. After coating the aforementioned TiO₂ film once with the prepared sol by using a spin-coating (3000 rpm) method and subsequently treating it with heat at 400° C., the photocatalytic characteristics of TiO₂ were evaluated for stearic acid by using the same method as Example 3.

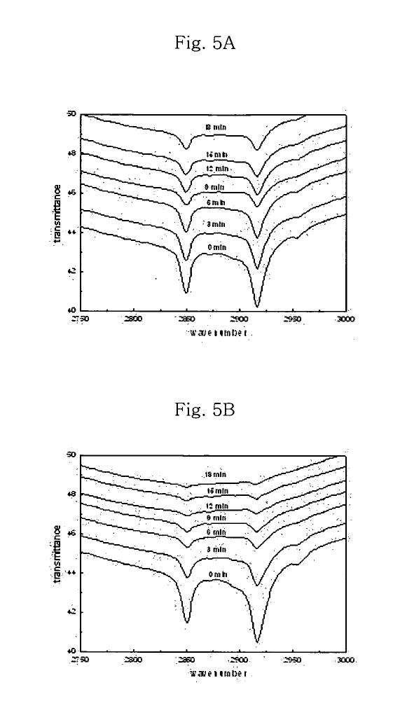

FIG. 5a is a graph illustrating the degradation behavior of stearic acid on the TiO₂ film not coated with MgO. Observing that the FT-IR spectrum intensity of stearic acid has decreased according to the photocatalytic reaction time but the peak of stearic acid has strongly remained even after the reaction, it is shown that stearic acid was not degraded thoroughly.

FIG. 5b is an FT-IR spectrum of stearic acid coating MgO on the TiO₂ film manufactured under the same conditions. It is shown that the degradability of stearic acid was a lot better, as compared with the TiO₂ film that is not coated with MgO.

### EXAMPLE 6

Under the same manufacturing conditions previously described in Example 2, the characteristics of the dye-sensitized TiO₂ solar cell were evaluated according to various metallic oxides such as magnesium oxide (MgO), calcium oxide(CaO), aluminum oxide (Al₂O₃), iron oxide (Fe₂O₃), lantanium oxide (La₂O₃), and so on containing nano-sized pores. As described in Example 2, Ball-Milling treatment was executed for 24 hours in order to uniformly coat each metallic hydrate obtained through hydration on TiO₂. At this point, content of each metallic oxide was standardized to be 0.06 wt %.

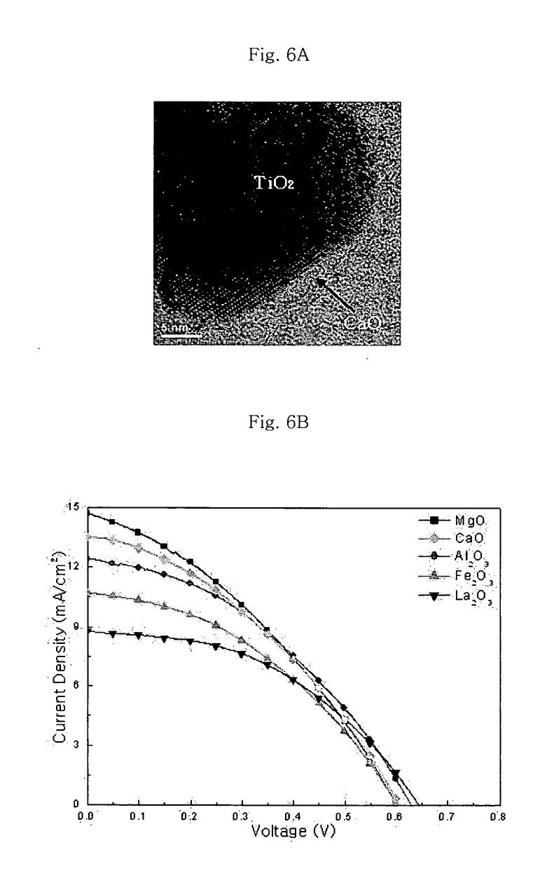

FIG. 6a is a transmission electron microscope photo illustrating the appearance of nano-sized calcium oxide layer that is uniformly coated around TiO₂. Evaluation of the characteristics of the solar cell was made under the same conditions as in Example 2 and this result is illustrated in FIG. 6b. Table 2 represents the light-to-electric energy conversion efficiency calculated from the measurements of the solar cell of FIG. 6b.

TABLE 2

| | Metallic oxides coated | | | | |
|---|---|---|---|---|---|
| | MgO | CaO | Al₂O₃ | Fe₂O₃ | La₂O₃ |
| Light-to-electric | 4.2 | 3.9 | 3.6 | 3.2 | 2.8 |
| energy conversion | | | | | |
| efficiency (%) | | | | | |

It is recognizable that the formation of the MgO or CaO coating layer among oxide coating layers is more desirable in order to augment the efficiency of the solar cell.

According to the methods of this invention, the uniform porous oxide layer of nano-sized thickness is formed on the TiO₂ particles or surface by using the characteristics of the topotactic phase transition between hydrates and oxides. The formed Porous oxide coating layer increases the absorption capacity of water or dye molecules by increasing the specific surface area of the titanium dioxide (TiO₂) particles, thereby improving the photocatalytic characteristics of TiO₂ or the dye-induced fuel cell.

Moreover, the oxides listed in this present invention can improve the absorption characteristics of the dye molecules containing acid by controlling the iso-electric point of the TiO₂ surface so as to be a base.

As a result, the TiO₂ powder or film manufactured by the methods of this present invention improves its degradation capacity for organic matters in the atmosphere. Additionally, if oxides with nano-sized pores are applied to the photocatalytic titanium dioxide (TiO₂), the TiO₂ powder or film not only increases the reaction area of TiO₂ by increasing surface area, but also enlarges the photocatalytic activity of TiO₂ by increasing moisture absorption capacity, thereby improving the degradation capacity for organic matters in the atmosphere. Thus, the TiO₂ can be properly used as a photocatalyst.

Furthermore, since the iso-electric point of the oxide coating layer itself is greater than that of titanium dioxide (TiO₂), more dyes can be absorbed into the surface. Therefore, when used as electrode material of the solar cell, the oxide coating layer can increase the light-to-electricity conversion efficiency of the solar cell.

Furthermore, the coating process to obtain nano-sized uniform oxide coating layer is so simple that photocatalyst and/or electrode material of good quality can be manufactured through simple processes.

It should be understand by those of ordinary skill in the art that various replacements, modifications and changes in the form and details may be made therein without departing from the sprit and scope of the present invention as defined by the following claims. Therefore, it is to be appreciated that the above described embodiments are for purpose of illustration only and are not to be construed as limitations of the invention.

1-16. (canceled)

17. A method of coating the nano-layer of porous oxides with hyperfine nano-sized pores on titanium dioxide (TiO₂), comprising the steps of:
providing a solution containing metallic salts;
providing the solution of the metallic salts with a titanium dioxide (TiO₂) powder;
hydrating the metallic salts and coating the hydrates on a surface of the titanium dioxide (TiO₂) powder; and
forming oxides from the hydrates coated on the titanium dioxide (TiO₂) powder surface.

18. A method of coating the nano-layer of porous oxides with hyperfine nano-sized pores on titanium dioxide (TiO₂), comprising the steps of:
providing a solution containing metallic salts;
forming hydrates through hydration of the metallic salts;
coating the hydrates on a TiO₂ powder surface by providing the solution with the TiO₂ powder; and
forming oxides from the hydrates coated on the TiO₂ powder surface.

19. A method of coating a porous oxide nano-layer with hyperfine nano-sized pores on titanium dioxide (TiO₂), comprising the steps of:
providing a solution containing metallic salts;
dipping a titanium dioxide (TiO₂) film in the solution of metallic salts;
hydrating the metallic salts and coating the hydrates on a surface of a TiO₂ film; and
forming oxides from the hydrates coated on the TiO₂ film surface.

20. A method of coating a porous oxide nano-layer with hyperfine nano-sized pores on titanium dioxide (TiO₂), comprising the steps of:
providing a solution containing metallic salts;
forming hydrates through hydration of the metallic salts;
dipping a TiO₂ film in the solution of metallic salts and coating the hydrates on a surface of the TiO₂ film;
forming oxides from the hydrates coated on the TiO₂ film surface.

21. The method of claim 17, wherein the hydrates include at least one selected from the group consisting of lantanium hydroxide (La(OH)₃), nickel hydroxide (Ni(OH)₂), calcium hydroxide (Ca(OH)₂), iron oxide hydroxide (FeOOH) aluminum hydroxide (Al(OH)₃), aluminum oxide hydroxide (AlO(OH)), and cobalt hydroxide (Co(OH)₂).

22. The method of claim 17, wherein the metallic salts include at least one selected from the group consisting of carbonates, nitrates, sulfates, ammonium salts, chlorides, organic salts, and alkoxides.

23. The method of claim 17, wherein the oxides includes at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO).

24. The method of claim 23, wherein the content of the metallic salts in the solution is selected so that the content of the oxides is within the range between 0.02 wt % and 10 wt % compared with titanium dioxide (TiO₂).

25. The method of claim 17, wherein the hydrates are formed at a temperature between 5° C.˜90° C.

26. A titanium dioxide (TiO₂) powder composed of TiO₂ particles, containing a porous oxide layer with a thickness less than 10 nm and a basic surface iso-electric point on a surface of the TiO₂ powder.

27. The titanium dioxide (TiO₂) powder of claim 26, wherein oxides forming the porous oxide layer include at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO).

28. The titanium dioxide (TiO₂) powder of claim 27, wherein the porous oxide layer is generated by a topotactic phase transition from metallic hydrates.

29. A titanium dioxide (TiO₂) film containing a porous oxide layer formed on a substrate and having a thickness of not more than 10 nm and a basic surface iso-electric point on a surface of the film.

30. The titanium dioxide (TiO₂) film of claim 29, wherein oxides forming the porous oxide layer include at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO).

31. The titanium dioxide (TiO₂) film of claim 29, wherein the pores of the oxide layer are generated by a topotactic phase transition from metallic hydrates.

32. A titanium dioxide (TiO₂) film composed of titanium dioxide (TiO₂) particles containing a porous oxide layer formed on a substrate and having a thickness less than 10 nm and a basic surface iso-electric point on a surface of the film.

33. The method of claim 18, wherein the hydrates include at least one selected from the group consisting of lantanium hydroxide (La(OH)₃), nickel hydroxide (Ni(OH)₂), calcium hydroxide (Ca(OH)₂), iron oxide hydroxide (FeOOH) aluminum hydroxide (Al(OH)₃), aluminum oxide hydroxide (AlO(OH)), and cobalt hydroxide (Co(OH)₂).

34. The method of claim 19, wherein the hydrates include at least one selected from the group consisting of lantanium hydroxide (La(OH)₃), nickel hydroxide (Ni(OH)₂), calcium hydroxide (Ca(OH)₂), iron oxide hydroxide (FeOOH) aluminum hydroxide (Al(OH)₃), aluminum oxide hydroxide (AlO(OH)), and cobalt hydroxide (Co(OH)₂).

35. The method of claim 20, wherein the hydrates include at least one selected from the group consisting of lantanium hydroxide (La(OH)₃), nickel hydroxide (Ni(OH)₂), calcium hydroxide (Ca(OH)₂), iron oxide hydroxide (FeOOH) aluminum hydroxide (Al(OH)₃), aluminum oxide hydroxide (AlO(OH)), and cobalt hydroxide (Co(OH)₂).

36. The method of claim 18, wherein the metallic salts include at least one selected from the group consisting of carbonates, nitrates, sulfates, ammonium salts, chlorides, organic salts, and alkoxides.

37. The method of claim 19, wherein the metallic salts include at least one selected from the group consisting of carbonates, nitrates, sulfates, ammonium salts, chlorides, organic salts, and alkoxides.

38. The method of claim 20, wherein the metallic salts include at least one selected from the group consisting of carbonates, nitrates, sulfates, ammonium salts, chlorides, organic salts, and alkoxides.

39. The method of claim 18, wherein the oxides includes at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO).

40. The method of claim 19, wherein the oxides includes at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO).

41. The method of claim 20, wherein the oxides includes at least one selected from the group consisting of magnesium oxide (MgO), calcium oxide (CaO), aluminum oxide (Al₂O₃), iron oxide (Fe₂O₃), lantanium oxide (La₂O₃), nickel oxide (NiO), and cobalt oxide (CoO).

42. The method of claim 39, wherein the content of the metallic salts in the solution is selected so that the content of the oxides is within the range between 0.02 wt % and 10 wt % compared with titanium dioxide (TiO₂).

43. The method of claim 40, wherein the content of the metallic salts in the solution is selected so that the content of the oxides is within the range between 0.02 wt % and 10 wt % compared with titanium dioxide (TiO₂).

44. The method of claim 41, wherein the content of the metallic salts in the solution is selected so that the content of the oxides is within the range between 0.02 wt % and 10 wt % compared with titanium dioxide (TiO₂).

45. The method of claim 18, wherein the hydrates are formed at a temperature between 5° C.˜90° C.

46. The method of claim 19, wherein the hydrates are formed at a temperature between 5° C.˜90° C.

47. The method of claim 20, wherein the hydrates are formed at a temperature between 5° C.˜90° C.
